(19) United States
(12) Patent Application Publication
(10) Pub. No.: US 2020/0346480 A1
(43) Pub. Date: Nov. 5, 2020

(54) NON-MAGNETIC ACCESSORIES FOR WHITE BOARD AND DISPLAY SYSTEM

(71) Applicant: Magnatag Inc., Macedon, NY (US)

(72) Inventors: Christian Q. Krapf, Rochester, NY (US); Michael DiRisio, Rochester, NY (US); Wallace A. Krapf, Macedon, NY (US)

(21) Appl. No.: 16/864,748

(22) Filed: May 1, 2020

Related U.S. Application Data
(60) Provisional application No. 62/841,293, filed on May 1, 2019.

(51) Int. Cl. B43L 1/12

(52) U.S. Cl. CPC B43L 1/12

(57) ABSTRACT

A display board system includes a display board with a clear or optically transparent dry-erasable writing surface and a plurality of accessories. The display board accessories include a support member having an engagement surface with a micro or nano-suction material including a plurality of bubbles or cavities filled with air that is configured to provide releasable and secure attachment of the accessory to the dry-erasable writing surface of the display board. The micro or nano-suction material of the accessories, which can include document holding apparatus, labels, letters, numbers, symbols, document holders, among others, releasably adhere to the dry-erasable writing surface of literally any display board and are not reliant upon either magnets or adhesives for retention.

### CROSS REFERENCE TO RELATED APPLICATION

This application claims priority to U.S. Ser. No. 62/841,293, filed May 1, 2019, entitled: White Board Display System Including Non-Magnetic Accessories, under relevant portions of 35 U.S.C. §§ 111, 119 and 37 CFR § 1.53, the entire contents of which is incorporated by reference.

### TECHNICAL FIELD

This application is generally directed to the field of display board systems and more specifically to a plurality of non-magnetic, non-adhesive accessories that are sized, configured and adapted for releasable attachment to a display board, and more preferably the dry erasable writing surface of a glass or optically transparent display board.

### BACKGROUND

The history of display boards and display board systems has evolved considerably over time. Initially, erasable slates were used for centuries until so-called “blackboards” became more widely known for classroom use on or about 1840, in which black or dark grey dry slate was used in combination with chalk (calcium sulfate or calcium carbonate). The markings made by chalk could be removed by means of a damp cloth, but often some markings would invariably remain. In the early 1960's, green porcelain enamel boards were developed, which created less glare and were better equipped to remove chalk markings. Still, these latter display boards had a number of disadvantages, including user allergies to the accumulated chalk dust, as well as occasional chalk breakage and issues relating to the scratching sounds made by the chalk against the blackboard or enamel board.

So-called “whiteboards” were subsequently invented in the 1960s when it was determined that enameled steel could be effectively used as a writing surface. These early display boards were very expensive, leading to cheaper versions being introduced that included laminated chipboard, high-pressure laminates and steel boards with a white, usually polyester or acrylic coating. Early whiteboards needed to be wiped with a damp cloth and markers had a tendency to leave marks behind, even after erasing the board. To cure this latter issue, dry-erase markers were invented in 1975, utilizing an erasable ink capable of adhering to the writing surface of the display board, but without binding to or being absorbed by the writing surface. This ink was easily erasable without leaving residual marks. With the advent of dry-erase markers and since the early 2000s, the demand for display board systems have since become very popular as a replacement for chalkboards in schools and also in businesses covering a varied number of fields including hospitals, industrial plants, military, and government, among many others.

In addition to the dry-erasable markers and erasers, other accessories have been provided to consumers as part of an overall display board system. These accessories include labels, die-cut letters and numbers, symbols, arrows, and the like, each of which included at least one magnet to permit releasable mounting to a steel-based display board, as needed, for purposes of tracking, planning or organizing activities, events, schedules, calendars and the like.

More recently, developments have been made in which various media can be printed directly onto a whiteboard, using for example, heat sublimation or other imbedding processes. As a result, grids, charts, tables, maps and other media, such as photographs, can be directly incorporated as part of the display board. This latter development has permitted even greater versatility, adding to a myriad of potential uses for dry-erase board systems that can be mounted to wall surfaces, cubicles, easels, kiosks and the like and increasing the need for board accessories, such as those described above.

As noted, the use of enameled or porcelain coated steel is very expensive. More recently and since the mid 2000s, clear transparent marking or writing surfaces have become available. These surfaces are generally manufactured from tempered glass that have been optically coated in order to create a writable dry-erase surface. Alternatively, coated acrylics have also been utilized. The writable dry-erase surface of these display boards can also be directly printed upon for purposes of creating charts, grids, tables, maps, schedules, etc., or the addition of other various media.

Existing display board accessories that are reliant upon magnets for support are less effective used on a glass, acrylic or other optically transparent or clear display board. Though a steel or aluminum backer plate may be used to support an optically transparent or clear dry-erase writing surface, the use of magnets is still markedly less effective given the distance or spacing between the magnet(s) and the backer plate. Moreover, magnetic accessories cannot be used effectively on optically clear display boards that do not include a frame or backer plate. Accordingly, there is a need in the field to provide an alternative source of display board accessories that are as effective and reliable as magnets, but specifically configured for use with optically transparent or clear display boards.

Other whiteboard systems are known in the field in the form of adhesive whiteboards. These latter display boards are made from materials, such as melamine coated materials that can be purchased in rolls, sheets and/or preformed boards. These latter display systems typically include an adhesive backing to permit the boards to be adhered to wall surfaces. While providing an option for display board accessories, the use of adhesives provides a number of disadvantages in terms of product life and the condition of the dry-erase writing surface as a result of continual accumulation of adhesive residue, resulting in breakdowns in the life of the accessories as well as the display board over time.

Accordingly, there is an existing need in the field to provide accessories that enable reliable and releasable attachment to the writing surfaces of display boards, preferably wet or dry-erasable writing surfaces made from glass or other optically transparent or clear materials. This need is prompted given the inability of magnetic accessories to successfully adhere to these latter display boards. It is a further need to enable the accessories to be used dynamically for charting, organizing or other related purposes, without relying upon an adhesive backing for contacting the display board.

### BRIEF DESCRIPTION

Therefore and according to a first aspect, there is provided an accessory for use with a display board having an optically clear or transparent dry-erase writing surface, the accessory comprising a support member having a first surface and an opposing second surface. The first surface is configured with micro or nano-suction material to enable releasable attachment of the accessory to the clear or transparent dry-erasable writing surface of the display board.

According to an exemplary embodiment, the accessory can include at least one of the group including labels, pre-cut numbers or letters, document holders, symbols or dots, among other accessories. In at least one version, the support member of the display board accessory can include at least one feature permitting the retention of a card or label to a top surface.

According to at least one version, the micro or nano-suction material is disposed onto an engagement surface of the support member. According to at least one embodiment, the micro or nano-suction material can be directly attached to the engagement surface of the support member. The micro or nano-suction material can include an adhesive layer that attaches to the engagement surface of the support member of the display board accessory, and an opposing surface having a plurality (hundreds) of tightly spaced micro or nano-cavities or bubbles that are filled with air and disposed in an array. The display board accessories can include at least one of the group consisting of labels, letters and numbers, symbols, and dots, among others. According to other versions, the accessory can be a hinged clip or document holder that can be attached to a glass or optically transparent display board.

Advantageously, the herein described accessories can be used to reliably adhere to display boards and more preferably to the writable wet or dry-erasable surface of an optically clear or transparent display board. The accessories do not leave an adhesive residue when removed and can be easily moved or relocated as needed onto any part of the dry-erase surface, for charting or other suitable purposes.

According to another aspect, there is provided a display board system, comprising a display board having an optically transparent or clear dry-erasable writing surface. At least one system accessory comprises a support member having a first surface and a second surface. The first surface has a section of micro or nano-suction material disposed thereon that is configured to releasably adhere to the dry-erasable writing surface of the display board.

According to at least one version, the clear or optically transparent dry-erasable writing surface is made from tempered glass or a suitably treated acrylic. The system accessories can include at least one of the group including, but not limited to labels, letters, numbers and symbols, among others. According to other variants, the display board accessory can also be a hinged clip, a document holder or an accessory support such as an eraser tray.

According to another aspect of the invention, there is provided a method for producing accessories for use with a display board having an optically transparent or clear dry-erasable writing surface. The method comprises providing an accessory support member having a first surface and an opposing second surface, and securing at least one section of micro or nano-suction material to the second surface of the accessory support wherein the micro or nano-suction material is configured to releasably adhere to a dry-erasable writing surface of an optically transparent or clear display board.

Advantageously, accessories in accordance with the present invention can be reliably attached and removed from literally any type of dry-erasable writing surface, and more preferably the writing surface of an optically transparent or a clear (glass or transparent plastic) display board without requiring either magnets or adhesives.

Another advantage realized is that the display board accessories made in accordance with the present invention are equally, if not more reliable in terms of shelf life, than existing or known magnet-based accessories. Literally any accessory typically used in conjunction with a steel display board can be suitably configured using a flexible micro or nano-suction suction material for adhesion in lieu of magnet(s).

Still further, the herein described accessories are easily and selectively movable upon the writing surface of the display board to permit set up and updating, such as for example, schedules, charts or tables, in which tabled parameters may vary periodically over time. The accessories can be moved easily and without the deleterious effects of adhesives and/or adhesive residue.

Micro or nano-suction material adheres very well to smooth surfaces and therefore provides effective and reliable retention to display boards, especially those having smooth dry-erase writing surfaces. Magnetic-based accessories, on the other hand, are limited in their function by the strength of the magnet as well as the distance of attraction through a non-magnetic surface, as would be found on plastic or display boards having an optically clear or transparent writing surface.

While micro or nano-suction material is susceptible to dirt, dust or other debris that may interrupt the suction bond to a support surface, this temporary lack of adhesion can easily be cured by rubbing away the debris using a micro-fiber cloth, permitting nearly unlimited use of the herein described accessories.

In addition, at least some of the accessories described herein can be printed upon, (e.g., a company logo, product identification number, reorder web-link, or any instructions pertaining to the attached product), while still retaining the ability to adhere to a display board surface. For example and in at least one embodiment, the micro or nano-suction material can be printed upon directly.

These and other features and advantages will be readily apparent from the following Detailed Description, which should be read in conjunction with the accompanying drawings.

### BRIEF DESCRIPTION OF THE DRAWINGS

The accompanying drawings described below are not necessarily to scale and should not be relied upon for scaling purposes. That is, the drawings are intended only to illustrate salient features of exemplary accessories for use in display board systems in accordance with aspects of the present invention.

FIG. 1 is a perspective view of known steel display boards having a dry-erasable writing surface;

FIG. 2(a) is a front view of a display board having an optically clear or transparent dry-erasable writing surface;

FIG. 2(b) is a side view of the display board of FIG. 2(a);

FIG. 2(c) is a side view of another display board having an optically clear or transparent dry-erasable writing surface;

FIG. 2(d) is an enlarged view of a top portion of the display board of FIG. 2(c) at A;

FIG. 2(e) is an enlarged view of a bottom portion of the display board of FIG. 2(c) at B;

FIG. 2(f) is a rear view of the display board of FIGS. 2(c)-(e);

FIG. 3(a) is a front perspective view of an embodiment of a display board accessory, which is made in accordance with aspects of the present invention;

FIG. 3(b) is a front facing view of the display board accessory of FIG. 3(a);

FIG. 3(c) is a rear perspective view of the display board accessory of FIGS. 3(a) and 3(b);

FIG. 3(d) is a rear facing view of the display board accessory of FIGS. 3(a)-3(c);

FIG. 3(e) is a side view of the display board accessory of FIGS. 3(a)-3(e);

FIG. 4(a) is a front facing view of a sheet of die cut letters and numbers that can be used as a display board accessory in accordance with certain aspects of the invention;

FIG. 4(b) is a side facing view of the sheet of FIG. 4(a), with the letters and numbers being configured as display board accessories;

FIG. 4(c) is a side view of one of the display accessories of FIGS. 4(a) and 4(b);

FIG. 4(d) is a front facing view of a sheet of die cut shapes that can be used as display board accessories in accordance with certain aspects of the invention;

FIG. 4(e) is a side view of one of the die cut shapes configured as a display board accessory;

FIG. 5(a) is a front view of a display board configured with a plurality of display board accessories in accordance with another embodiment;

FIG. 5(b) is an enlarged front perspective view of one of the display board accessories of FIG. 5(a);

FIG. 5(c) is another enlarged view of one the display board accessory of FIGS. 5(a) and 5(b);

FIGS. 5(d)-5(i) are side views of the display board accessories of FIGS. 5(a)-5(c) in various sizes;

FIG. 6(a) is a front perspective view of a display board having mounted display board accessories in accordance with yet another embodiment;

FIG. 6(b) is a front perspective view of one of the display board accessories of FIG. 6(a);

FIG. 6(c) is a side view of the display board accessory of FIGS. 6(a)-6(c);

FIG. 7(a) is a side view of a display board accessory made in accordance with yet another embodiment;

FIG. 7(b) is a front perspective view of the display board accessory of FIG. 7(a);

FIG. 8(a) is a side view of a display board accessory made in accordance with another embodiment of the present invention;

FIG. 8(b) is a rear facing view of the display board accessory of FIG. 8(a); and

FIG. 8(c) is a front perspective view of the display board accessory of FIGS. 8(a) and 8(b).

### DETAILED DESCRIPTION

The following describes a number of accessories made in accordance with various embodiments that can be used in conjunction with a display board as part of an existing system or alternatively as separate components. Though the herein described accessories can be used with literally any display board, the described accessories are preferably and advantageously used with a display board having an optically transparent or clear dry erasable writing surface.

Throughout the course of discussion, a number of terms are used in order to provide a suitable or adequate frame of reference relative to the accompanying drawings. These terms, such as “inner”, “outer”, “front”, “back”, “above”, “below”, “internal”, external”, “left”, “right” and the like are not intended to be overlimiting of the present invention, except where so specifically indicated.

In brief, a number of display board accessories are described, shaped and configured herein for releasable attachment to a writing surface of a display board, including but not limited to dry-erasable writing surfaces. These accessories do not rely upon either an adhesive or magnets to guarantee reliable adhesion and releasable removal/replacement of same from the display board.

For purposes of this description, a number of terms are frequently used in order to describe aspects of the invention. The intended definitions of these terms is as follows: First, the term “display board” refers to any form of free-standing structure that can also be secured to a surface, such as a wall and includes at least one surface capable of affixing display media or otherwise configured to provide a presentation whether graphical, pictorial or similar. For purposes of this description the term “white board” refers to any display board having a dry-erasable writing surface. A “dry-erase” or “dry-erasable writing surface” as used herein refers to a wipeable writing surface that enables the use of dry-erase markers. A “wet-erase” or “wet-erasable” writing surface permits wiping using a wet cloth. A “magnetic display board” as used herein refers to a display board in which the writing surface is made from a material (typically steel) that adhesion of magnets and magnetic display board accessories. A “glass” display board as used herein synonymously throughout this description, along with the term “transparent display board” refers to any display board having an optically transparent or clear dry-erase writing surface.

Any of these latter display boards may include a framework or other supporting structure that is configured to enable the display board to be mounted to a wall or other surface in which all or part of the display board includes a wet or dry-erase writing surface. According to another version, the display board can itself form the wall of a structure or a wall of a cubicle.

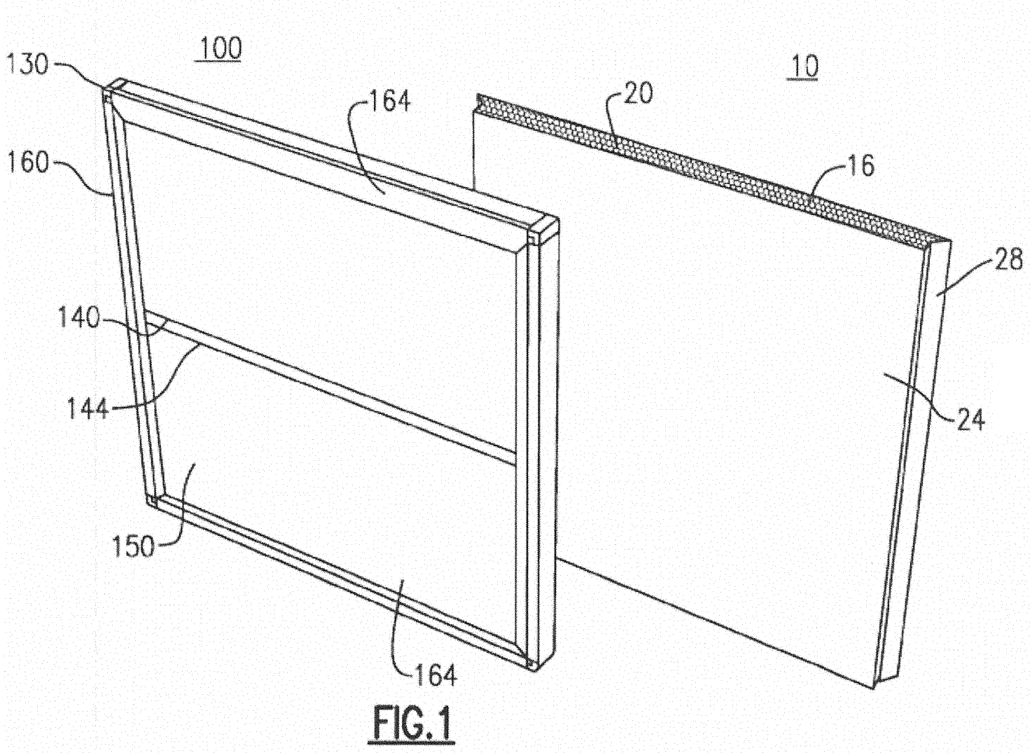

With reference to FIG. 1, there is first shown a known display board herein described for purposes of background. The display board 10 is defined by a substantially rectangular configuration, made up of three (3) major components; namely, a top layer 16, an intermediate or core layer 20 and a backing layer 24. The top layer 16 is made from a thin planar steel sheet having a ceramic or other suitable dry-erase coating layer that is applied to a front facing surface thereof. It should be noted that the application process and specific formulations of dry-erase coatings are not a specific part of this invention. A number of examples of these are found in the field such as those described in U.S. Pat. Nos. 7,985,472 and 6,620,500, the contents of which are incorporated by reference in their entirety.

The intermediate core layer 20 is defined by a composite honeycombed material section, which is formed by paper or corrugated cardboard, and is appropriately sized to be fitted to the top layer 16. The rear or backing layer 24 is made from a thin planar sheet of material, such as aluminum, that is sized to cover the intermediate core layer 20. In terms of assembly, the intermediate core layer 20 is adhered to the rear surface of the formed steel sheet (top later 16). Lateral edge portions 28 of the top layer 16 are bent outwardly to permit overlap of multiple panels (not shown) and to obscure the interior features of the formed panel 10.

The top layer 16 defines a dry-erase writing surface that permits a number of display board accessories to be releasably attached, including labels, numbers, letters, and the like, each of the accessories including at least one magnet that is attracted to the steel dry-erase surface of the display board. The herein display board 10 may be supported by a suitable framework or may itself form a wall panel. Still referring to FIG. 1, a comparable known panel 100 includes a rear backing surface 150 permitting access to an intermediate cleat or insert 140. A longitudinal support slot 144 spans the width dimension of the cleat 140, the panel 100 further including a frame 160 including a plurality of side trim sections 164 that are disposed between a core layer and lateral side edges of the panel.

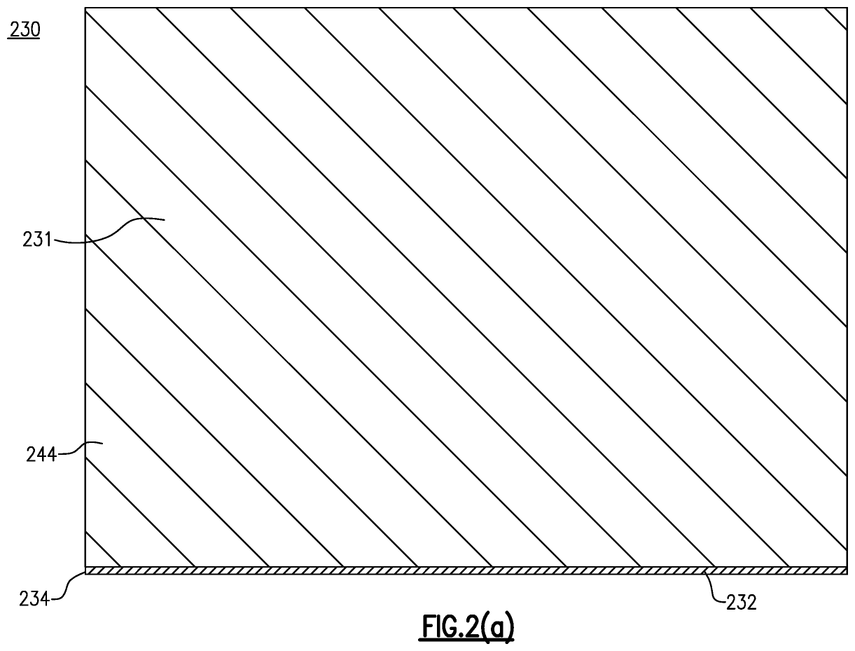

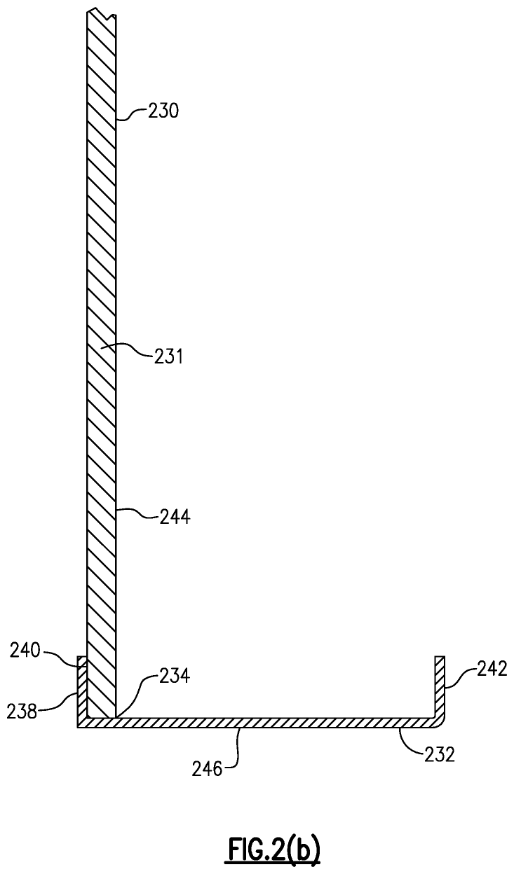

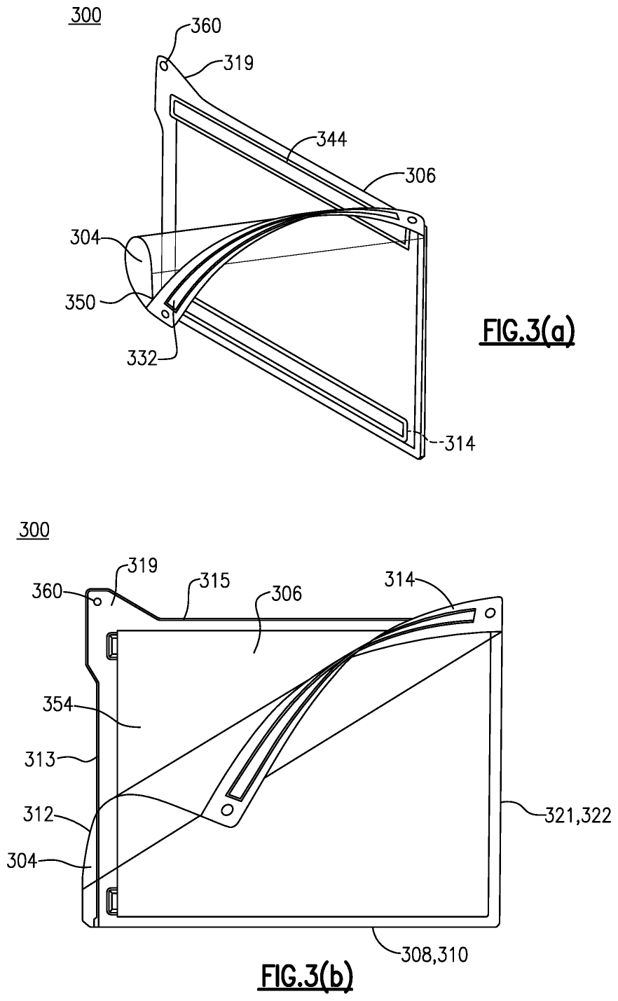

FIGS. 2(a) and 2(b) depict another known display board 230 that includes a planar sheet of tempered glass 231 having a smooth glass surface 244 on one side of the glass sheet 231 and an optional frosted surface on the other side of the glass sheet 231 facing a wall (not shown) or other supporting surface (not shown). The smooth glass surface 244 provides a smooth, hard surface which a user may write indicia with, for example, and among other things, a conventional dry-erase marker. The frosted surface may further include an opaque white paint layer to provide a white background for the transparent writing surface 244. The frosted surface can be ink-printed, powder coated, painted or simply left transparent with a white backer applied to it. Alternatively, the rear surface of the glass board 230 may include sheeting such as paper, plastic or cloth to provide non-image reflecting or non-specular and relatively sharp contrast background (e.g., white) for writing on the glass writing surface 244 with a contrasting colored material. The tempered glass sheet 231 may be made of clear glass to maximize transparency, but it may also be made from colored transparent glass, which may provide reduced transparency while providing, for example, enhanced aesthetic or architectural appearance.

The glass display board 230 can include a marker or eraser metal or plastic tray or other holder 232 for presentation materials. The tray 232 may extend along the lowermost edge 234 of the glass sheet 231 of the display board 230, although the tray 232 can be configured differently or mounted differently on the display board 230. According to this embodiment, the tray 232 is defined by a substantially U-shaped configuration 236, with one arm 238 secured to the back side 240 of the display board 230 and an opposing arm or lip 242 extending upwardly, but separated from the smooth writing surface 244 of the board 230. A planar tray element 246 extends laterally between the opposing arms 238, 240, while partially abutting the bottom or lowermost edge of the glass sheet 231.

Prior to assembly, the front facing surface of either display board 100, 230 can further include printing on all or part of the wet or dry-erase writing surface that is applied thereto. For example and according to one version, this printing can include at least one grid, chart or table having a series of lines, rows and or columns. According to another version, a map or other suitable image can be directly printed onto the front facing surface of the display board by means of a process such as thermal sublimation.

Yet another display board 250 having a optically transparent or clear wet or dry-erasable writing surface is shown in FIGS. 2(c)-2(f). This display board 250 according to this embodiment is defined by an extruded aluminum sheet which forms a back layer or plate that further includes frameless aluminum extrusions 258, 262 at respective upper and lower portions of the rear side of a steel backing sheet 254. According to this specific embodiment, the steel backing sheet 254 is a planar section of stainless steel having a thickness of 0.024″. A section of tempered glass 266 having a front facing side is secured by known means to the steel backing sheet 262. The extrusions 258, 262 include standoffs made from aluminum or other suitable material at the top and bottom, respectively, to provide spacing between the rear of the display board 250 and a wall (not shown) enabling the placement of a hidden pen/eraser holder 280, each extrusion being spaced along the length of the display board 250 to permit attachment using fasteners 264 attached through mounting holes formed in each extrusion 258, 262. According to this embodiment, the eraser holder 280 includes a plurality of pen receptacles, each being sized to retain a dry-erase marker pen 284, as well as an eraser receptacle for retaining an eraser 288. The front facing side of the tempered glass section 266 forms a dry erase writing surface.

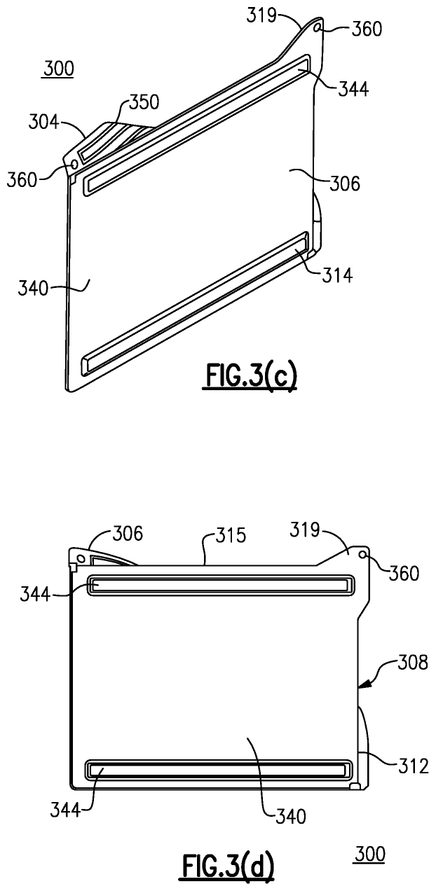

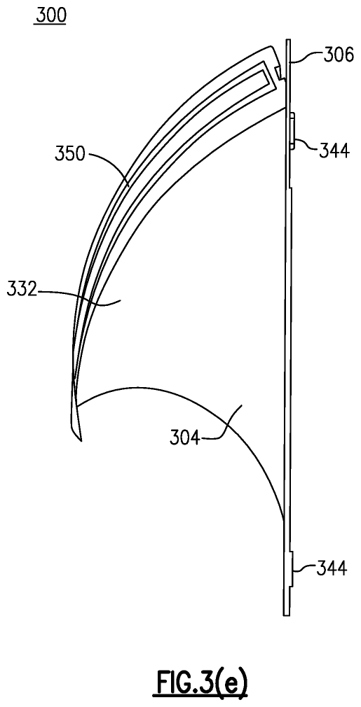

With reference to FIGS. 3(a)-3(e), a display board accessory 300 made in accordance with a first embodiment is herein described. The display board accessory 300 is defined by a pair of panel members and more specifically a top panel member 304 and a bottom panel member 306. Each of the top and bottom panel members 304, 306 are made from a flexible material in which at least the top panel member 304 is optically clear or transparent. Marginal portions of the lower edges 308, 310 of the top and bottom panel members 304, 306 are heat sealed or otherwise secured together in order to form a closed seam, the latter extending along and closing the lower end of the accessory 300.

As shown in the figures and according to this embodiment, the top panel member 304 is slightly longer and wider than the rear panel member 306, so that the marginal portions of the left side edge 312 and upper edge 314 of the top panel member 304 extend slightly beyond the left side edge 313 and upper edge 315 of the bottom panel member 306, with the exception of an upper tab portion 319 of the bottom panel member 306 in its upper left hand corner, as shown. Marginal portions of the right side edge 321, 322, as depicted, of the top and bottom panel members 304, 306 are heat sealed or otherwise secured together to form a seam that closes the right side of the accessory 300. The upper edge 315 of the bottom panel member 306 and the left side edge 313 of the bottom panel member 306 are not secured in any way to registering portions of the top panel member 304, enabling a triangularly shaped portion 332 of the top panel member 304 bound by its intersecting lower and right side edges to be moved or folded away from the registering portions of the bottom panel member 306.

A rear facing surface 340 of the bottom panel member 306 includes two elongate sections 344 that extend longitudinally in spaced parallel relation to each other, and adjacent and parallel to the upper and lower edges of the bottom panel member 306. According to this embodiment, each of the elongate sections 344 include a micro or nano-suction material, which can be provided in strips or alternatively in a rolled form.

Each of the elongate sections 344 of the micro or nano-suction material includes an adhesive back surface, which can be secured to the rear facing surface 340 of the bottom panel member 306. A plurality of tightly spaced cavities are provided on an opposite side of the tape. These spaced cavities contain air, which is squeezed out when the surface of an object, such as the dry-erase surface of a display board, is pressed against the surface of the material. A vacuum is created in the cavities, creating a plurality of vacuum chambers with a seal being formed between the cavities and the surface of the object to which the accessory 300 is attached. Due to external air pressure, this vacuum creates a cohesive force that prevents removal of the micro or nano-suction material from the object, a mechanism functionally analogous to a suction cup. A significant force is required in order to detach the accessory having the micro or nano-suction material from the object by pulling the accessory in a direction perpendicular to the formed seal since the overall contact area is significantly large. However, it is easy to peel the accessory from the object starting from an edge of the contact area for purposes of removal as only a small number of the created vacuum chambers are detached at a time, and in which each individual vacuum chamber generates a relatively small weak opposing force given its small contact surface. The micro or nano-suction material is not pressure sensitive and is designed for multiple applications. In addition, the contact surface, including the micro or nano-suction material of the herein described accessory 300, can be wiped between uses in order to remove dirt or debris that can develop or otherwise accumulate.

In assembly, the micro or nano-suction material can be provided in sheets that can be cut to an appropriate size, each of the sheets further including a protective backing that is peelably removable from the adhesive back surface. The elongate sections 344 of micro or nano-suction material are then secured to the rear facing side 344 of the bottom panel member 306 with the release strip being removed prior to use. One example of a suitable micro or nano-suction material is commercially available under the tradename Airstick™, which is manufactured by the Sewell Corporation. Other versions, however, are also commercially available. According to another version applicable to each of the herein described embodiments, the micro or nano-suction material can include a plurality of tightly spaced bubbles as previously described on both sides of the material sheets in lieu of an adhesive layer, for enabling the material to be attached to the remainder of the display accessory 300. The elongate sections 344 of micro or nano-suction material enables securement of the accessory 300 to the dry-erase display surface of a clear or transparent white board without requiring either magnets or adhesives.

In addition and according to at least one version, the micro or nano-suction material can permit printing thereon. For example, a company logo, product identification number, reorder web-link, or any instructions pertaining to the attached product can be provided conspicuously without otherwise interfering with the adherence of the accessory 300 to a display board or other smooth surface. The herein described accessory 300 can be suitably and releasably mounted to steel or glass (transparent) display boards, such as those shown in FIGS. 1 and 2 since the accessory 300 is not reliant upon magnetic attraction.

In addition and in order to maintain the front panel member 304 releasably closed over the bottom panel member 306, when the accessory 300 is mounted to a display board (not shown), an elongate flexible strip 350 of micro or nano-suction material is secured to and extends longitudinally of the top panel member 304. The flexible strip member 350 extends immediately adjacent to and parallel to the upper edge 314 of the top panel member 304, which as noted extends above the upper edge 315 of the bottom panel member 306. Accordingly, and when the accessory 300 is mounted to the dry-erase surface of a display board, the flexible strip 350 adheres to the dry-erase surface and the extending tab portion 319 of the bottom panel member 306, and maintains the front panel member 304 in its closed position.

In use, the accessory 300 is mounted using the elongate sections 344 of micro or nano-suction material to the face of the display board. A document 354 can then be inserted into the accessory 300 by grasping the upper left-hand corner of the front panel member 304 and then withdrawing the elongate strip 350 away from the extending tab portion 319 of the bottom panel member 306 and the display board. This will cause the above-noted triangularly shaped portion 332 of the top panel member 304 to be drawn away from the bottom panel member 306, enabling the accessory 300 to be opened for purposes of inserting or withdrawing a document(s) 354. Once the document 354 has been inserted into the accessory 300, the upper left hand corner can be returned to its closed position at which time the elongate strip 350 of micro or nano-suction material will be held releasably against the face of the display board, thus enclosing the document within the accessory 300. The accessory 300 is otherwise secured to the display board using the resilient strips 344 secured to the rear facing surface 340 of the bottom panel member 306. The herein described accessory 300 can be mounted vertically or horizontally, depending on the specific use.

Advantageously, no special clips or brackets are required to mount the herein described accessory 300 to a display board or for retaining the front panel member 304 in its closed position. Additionally, the accessory 300 provides a ready means for displaying retained documents while also protecting the documents against damage. Advantageously, it is not necessary to separately remove the accessory 300 from the display board in order to insert or withdraw a document.

In addition, the top panel member 304 is clear or transparent so that any document enclosed therein can be easily seen. Moreover and to enable identifying information or data to be provided on the face of the accessory 300 concerning the retained document or otherwise, the top panel member 304 can be made from a transparent vinyl material that enables write on/write off using a dry-erase or similar marker as part of a wipeable outer surface. Alternatively, an elongate flexible strip (not shown) of a flexible write-on material can be attached to the top panel member 304 to provide a convenient wipeable surface for marking or otherwise printing data on the face of the accessory 300.

The herein described accessory 300 can also include optional holes 360, which are provided in the upper corners of the front panel member 304 and extending tab portion 319 of the bottom panel member 306 to enable the accessory 300 to be hung vertically or horizontally, if needed.

In lieu of micro or nano-suction material, other means can be employed to permit opening and closing of the herein described accessory 300. For example and according to one version, the extending tab portion 319 can include a magnet (not shown) secured to a front facing side and a corresponding magnet (not shown) can be disposed in the upper left hand corner of the top panel member 304 to enable closure of the triangularly shaped portion 322 through magnetic attraction.

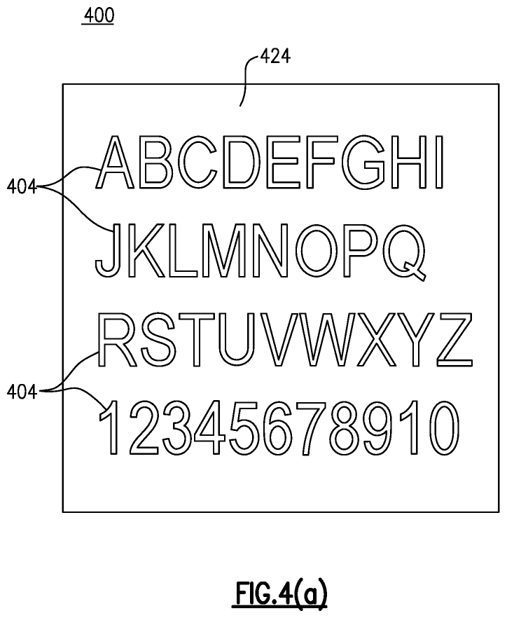

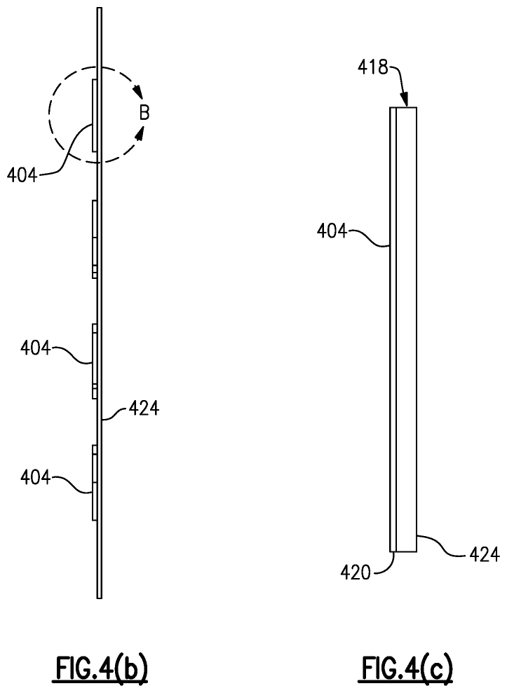

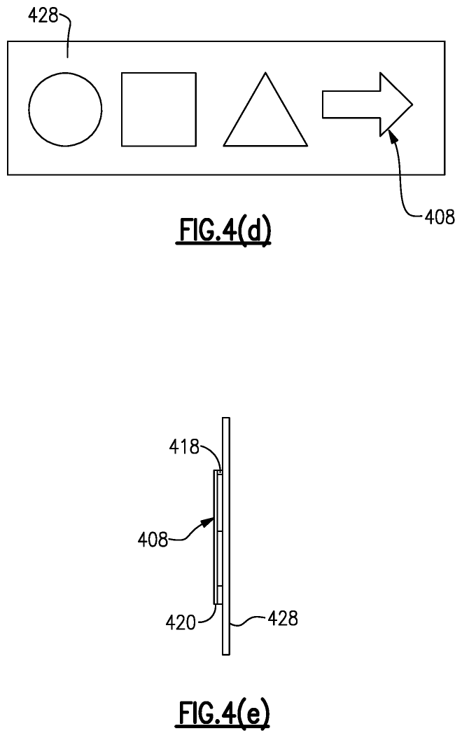

With reference to FIGS. 4(a)-4(e), display board accessories in accordance with a second embodiment are shown. According to this embodiment, a plurality of die cut letters and numbers 404, FIG. 4(a), or shapes 408, FIG. 4(d), are provided. The die-cut letters, numbers and shapes that are depicted are intended to be examples. It will be understood that other suitable versions in various colors and sizes can be similarly configured. According to this embodiment, each of the letter, numbers and shapes are fabricated from a colored vinyl material and include a section of micro or nano-suction material 418 that is secured to a rear facing surface 420. The micro or nano-suction material, as previously described includes a plurality of tightly spaced bubbles or cavities that are arranged on a facing surface of a highly flexible strip to create a vacuum seal when the material is pressed into the surface of an object with the air being pushed out of the cavities. In one version, the micro-or nano suction material can include an adhesive layer opposite the facing surface having the plurality of tightly spaced cavities or alternatively can also include a plurality of tightly spaced cavities on both sides. According to yet another embodiment, the micro or nano-suction material can be integral to the accessories.

According to this specific embodiment, plastic storage sheets 424, 428 are provided for the letter and number sets 404 and 408, respectively, enabling any of the accessories 404, 408 to be moved to and from the plastic sheets 424, 428 for attachment to the dry-erase surface of a display board. As in the preceding discussion, the micro or nano-suction material of each accessory enables releasable, but secure attachment to a smooth surface and does not rely upon either magnets or adhesives for retention. As such, the herein described accessories 404, 408 can be used with literally any form of display board, including steel or glass (clear or optically transparent) versions.

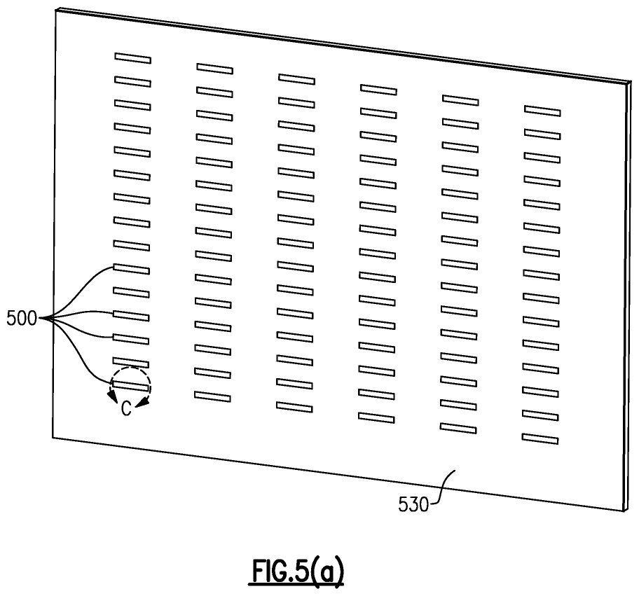

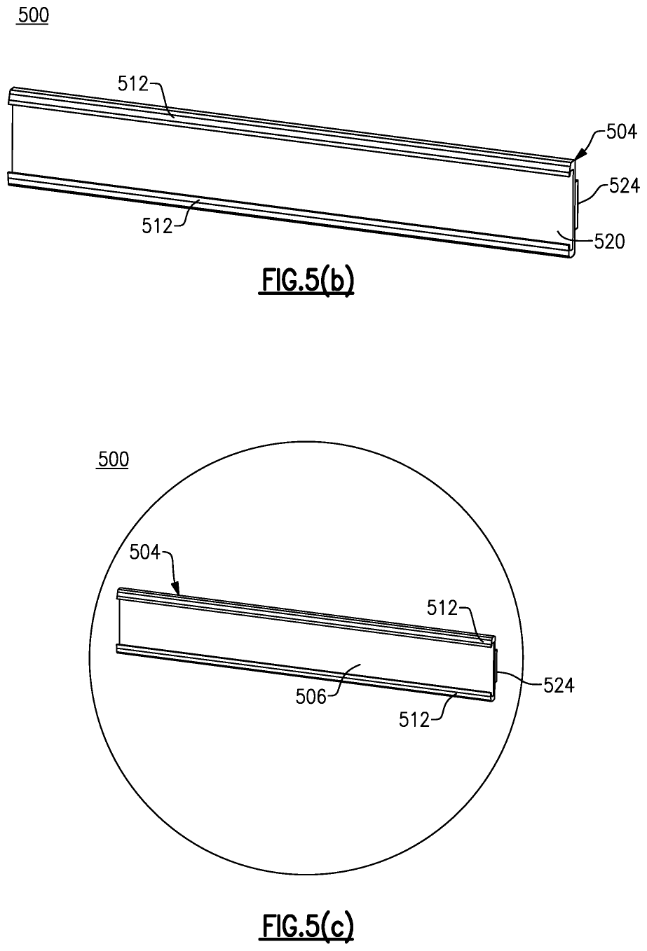

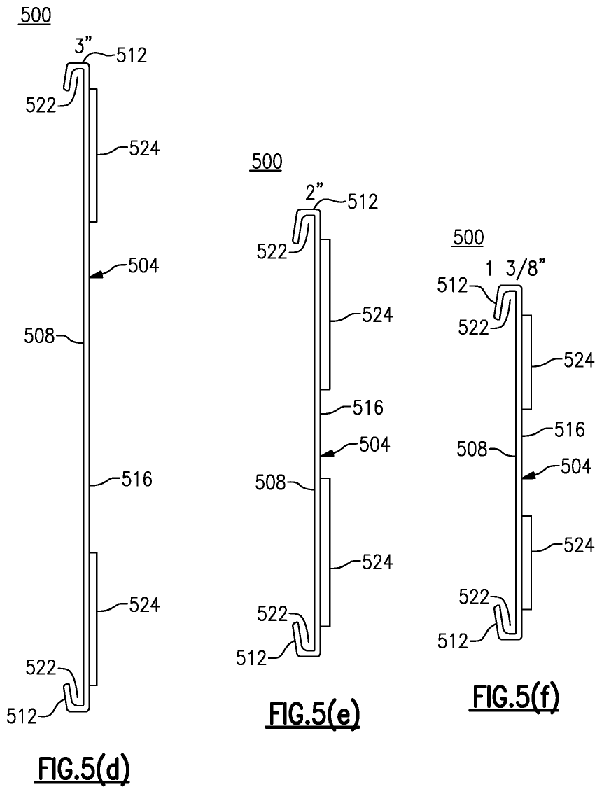

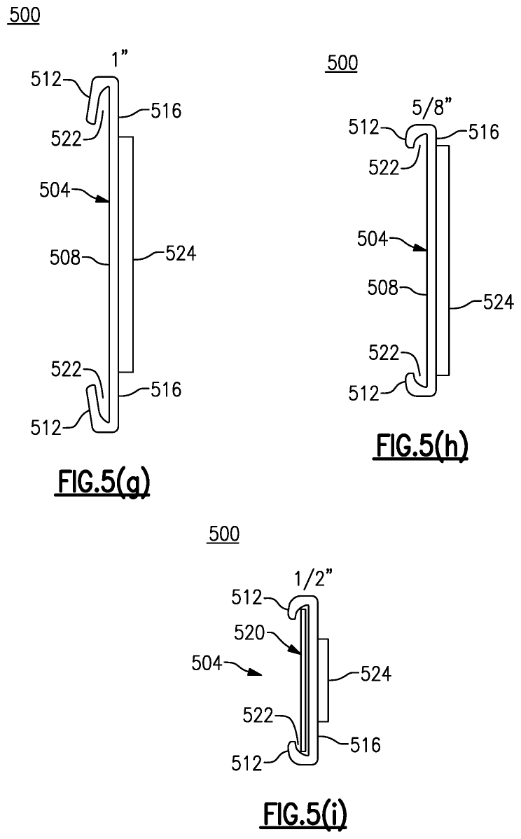

As shown in FIGS. 5(a)-5(i), another embodiment of a display board accessory 500 in accordance aspects of the present invention is herein described. The accessory 500 according to this version is a cardholder which is defined by a support member 504 that is made from a lightweight material, such as a moldable plastic. The support member 504 is defined by a substantially rectangular shape that further includes a top or front facing side 508 having a pair of spaced parallel rails 512 at upper and lower edges thereof. It will be understood that the shape and size of the accessory 500 can be suitably varied, depending on use.

The pair of spaced parallel rails 512 permit the inclusion of a card or label 520 fitted between the rails 512, and more specifically within channels 522 defined within each rail 512. The channels 522 according to this version are substantially C-shaped and extend over the span or length of the upper and lower edges of the support member 504. The support member 504 of the herein described accessory 500 can be made in a plurality of colors for purposes or use in organizing, charting and other display functions, depending on the specific application or field of use (e.g., governmental, industrial, educational, etc).

A back or rear surface 516 of the support member 504 is configured with at least one section 524 of a micro or nano-suction material to enable releasable attachment of the accessory 500 to the dry-erase writing surface of a display board. According to this specific embodiment, the micro or nano-suction material 524 includes an exterior facing side that includes a plurality (e.g., hundreds) of tightly spaced cavities or bubbles, as previously described, and an adhesive layer on an opposite side of the material 524 that can be secured to a back surface of the support member 504. Alternatively, the micro or nano-suction material can include the plurality of tightly spaced cavities or bubbles on both sides. According to yet another version, the micro or nano-suction material can be integrated into the remainder of the accessory by suitable means (stitching, welding, etc).

A release layer (not shown) can optionally be provided on the side of the material 524 having the tightly spaced cavities or bubbles prior to use of the accessory 500. As shown in FIGS. 5(d)-5(i), this accessory 500 can be provided in any varied number of sizes and/or colors in which one or more of the accessories 500 can be releasably attached to the dry-erase surface of a transparent or clear display board 530, as shown in FIG. 5(a), as part of an overall display board system.

It should be understood that the display board accessories made in accordance with this invention can take on many forms and can be shaped and suitably configured for use with various display boards, whether having a plastic or glass transparent or a steel dry-erase writing surface.

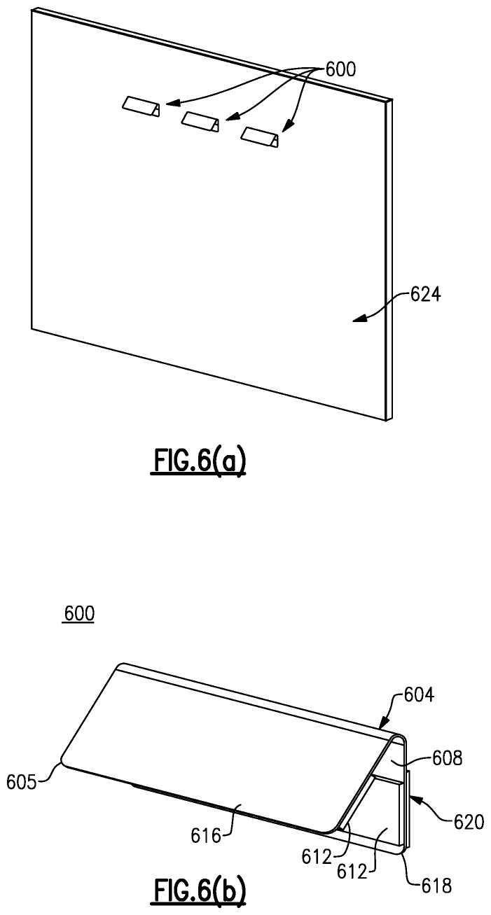

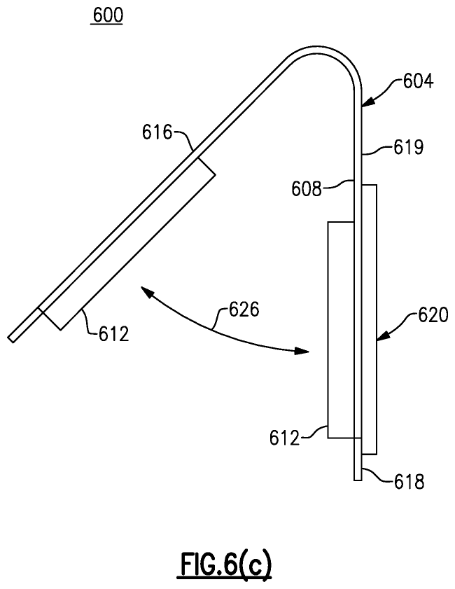

With reference to FIGS. 6(a)-6(c), a display board accessory made in accordance with a fourth embodiment is described. According to this specific embodiment, the display board accessory 600 is a hinge clip that utilizes a pair of magnets that are supported and hinged together by a U-shaped strip member 604. The U-shaped strip member 604 is biased into a closed or clamped position with the magnets 612 in contact with one another. The accessory 600 can be opened to releasably clamp a plurality of sheets of paper and the like between the magnets 612.

According to this specific embodiment, the U-shaped strip member 604 is made from an elongate sheet of a rigid, plastic material, such as a rigid vinyl. Prior to forming or bending into a suitable U-shape, the elongate sheet is defined by a substantially rectangular configuration having rounded corners 605. Secured to one face 608 of the strip member 604 between and parallel to its longitudinal side edges are two spaced, longitudinally extending magnetic strips 612, which are made from a flexible magnetic material. The strip member 614 is heated and folded about a center fold of the strip member 614 so as to assume the U-shaped configuration, which is defined by a pair of leg sections 616, 618 with the magnetic strips 612 facing one another on formed interior sides on the face 608 of the strip member 604.

A rear facing surface 619 of one of the leg sections 618 includes at least one section of micro or nano-suction material 624 that is secured by suitable means to the rear facing surface 619 and configured to enable the accessory 600 to be releasably secured to a display board 628, as shown in FIG. 6(a). According to one version, the micro or nano-suction material includes an adhesive layer on one side and a plurality of tightly spaced bubbles or cavities on an opposite facing side, with the adhesive layer being attached to the leg sections 618. According to another version, the facing side and opposing side of the material 624 can include the plurality of tightly spaced cavities or bubbles. In another version, the micro or nano-suction material 624 can be stitched or otherwise integrated into the leg section 618.

In use, the pair of opposed magnets 612 are initially configured to be in contact with one another with the accessory 600 being in its biased (closed or clamped) position. At least one sheet of paper, document, or other similar material can be inserted and securely retained between the magnets 612 by pulling the leg sections 616, 618 apart, as shown by arrow 626. In this specific embodiment, the outer surface of at least one of the leg sections 616 of the accessory 600 can optionally be provided with a wipeable or dry-erase writing surface. The tightly spaced bubbles or cavities of the micro or nano-suction material 624 create adhesion with the writable dry-erase surface 632 of the display board 628 and enable the accessory 600 to be releasably attached to and removed from the display board, as needed.

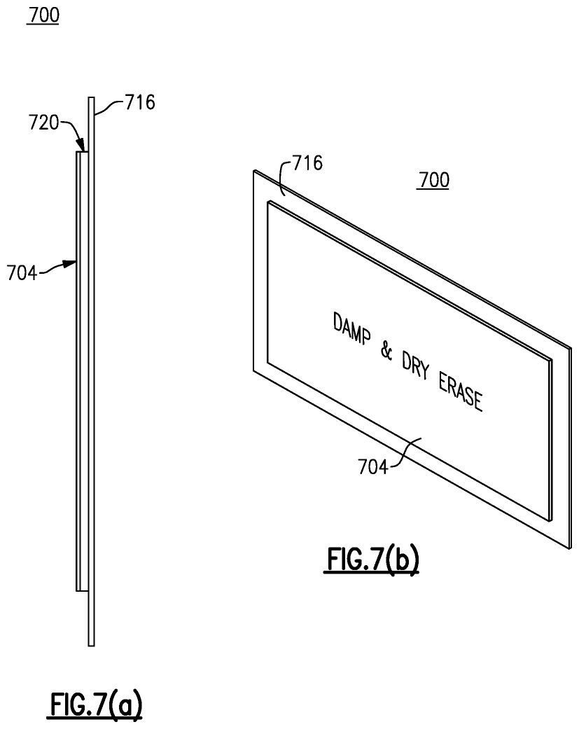

A display board accessory made in accordance with a fifth embodiment is described with reference to FIGS. 7(a)-7(b). According to this embodiment, the display board accessory 700 is a label that is defined by a support member 704, which is substantially planar and includes a first surface or side 704 and an opposing second surface or side 708. A section 720 of a flexible micro-suction material is secured by suitable means to the second surface 708. As in the previous embodiments, the micro or nano-suction material is defined by a flexible support having a plurality of tightly spaced bubbles or cavities on a facing side. The opposite side of the material can have an adhesive layer that is secured to the second surface 708. Alternatively, both the facing surface and the opposing surface can include a plurality of the tightly spaced bubbles or cavities. In another version, the section of micro or nano-suction material can be stitched or otherwise integrated into the second surface 708.

According to this specific embodiment, the first surface 704 of the support member 704 includes a erasable write-on surface, made from vinyl or other suitable material, which is wipeable. A plastic sheet 716 is used upon which a plurality of the accessories 700 can be attached in lieu of a writable dry-erase surface of a display board. When not in use, the accessory 700 can be attached to the plastic sheet 716 and releasably pulled or peeled from the sheet 716 when in use for adhering to a display board (not shown). The accessory 700 shown is simply an example. That is, the herein described accessory 700 can assume a myriad of shapes, sizes and colors.

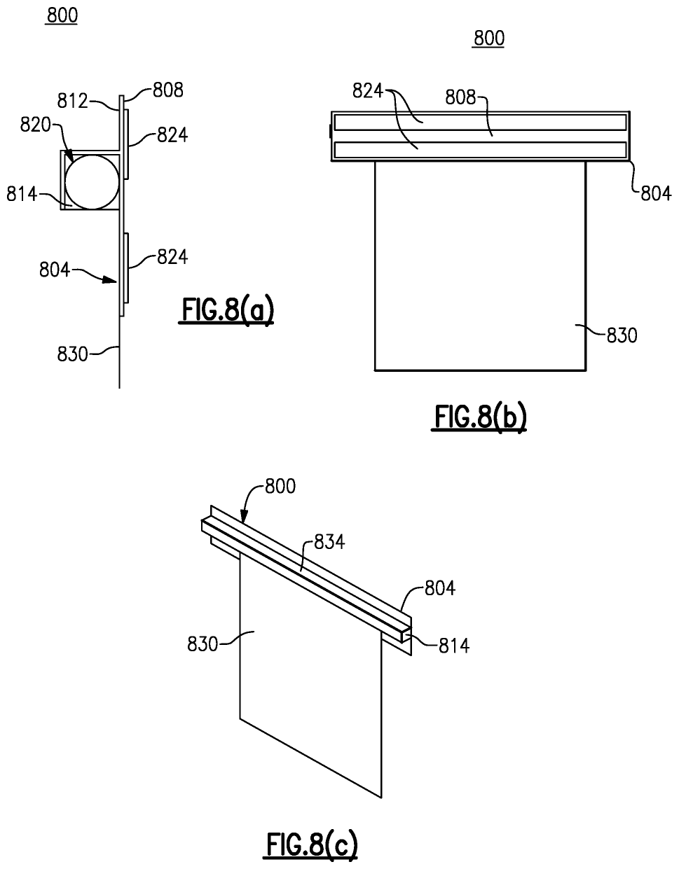

A display board accessory made in accordance with a sixth embodiment is described with reference to FIGS. 8(a)-8(c). This accessory 800 according to this specific embodiment is a document holder that is defined by a substantially rigid panel 804 having a bottom or rear side or surface 808 and an opposing top or front side or surface 812. A transparent, elongate enclosure 814 projects from the front side 812 of the panel 804, with a flexible retainer strip 820 being housed within the flexible enclosure 814. According to this embodiment, at least one elongate section of a flexible micro or nano-suction material 824 is fixedly secured to the rear facing surface 808 of the panel 804, enabling the accessory 800 to be releasably mountable to the dry-erase writing surface of a clear or transparent display board (not shown).

As in the preceding, the flexible micro or nano-suction material 824 is defined by a plurality of tightly spaced air filled bubbles or cavities on one facing side of a highly flexible support. When the micro or nano-suction material 824 is placed in compressive contact with a smooth surface, such as the dry-erase writing surface of a clear or transparent display board, the air is forced from the cavities and a vacuum-like seal is created. The section of micro or nano-suction material 824 can include an adhesive layer on a side of the support opposite that of the facing side that adheres to the rear facing surface 808 of the panel 804 or can be otherwise attached or secured. In at least one version, the micro or nano-suction material can be integrated directly into the panel 804.

The flexible retainer strip 820 according to this specific embodiment is defined by an elongate transparent strip of a film material, such as acetate or similar material, in which the retainer strip 820 is wound into a coiled configuration and disposed within the transparent enclosure 814. The diameter of the wound retainer strip 820 is smaller than the interior of the transparent enclosure 814 and therefore the wound retainer strip 820 is compressed within the confines of the transparent enclosure 814. More specifically, the retainer strip 820 is retained between the front surface 812 of the panel 804 and at least one interior wall of the transparent enclosure 814.

In use, the rear facing surface 808 of the panel 804 of the accessory 800 and more specifically the section(s) 824 of micro or nano-suction material can be releasably mounted to the dry-erase writing surface of a display board (not shown) with the transparent enclosure 814 being disposed upwardly. As discussed, air contained in the plurality of tightly spaced cavities or bubbles of the micro or nano-suction material is forced out under compressive contact with dry-erase writing surface, creating a durable vacuum seal.

At least one document 830 can be slidably inserted beneath the resilient strip 820 until the upper edge 834 of the document 830 approaches the portion of the resilient strip 820 that is fastened to the transparent enclosure 814. The presence of the document 830 beneath the resilient strip 820 causes a portion of the strip 820 to be urged resiliently against the face of the document 830 adjacent the upper edge 834 of the document 830, and in doing so frictionally and resiliently retains the document 830 against the second surface 812 of the panel 804. In this position, any printed material on the supported upper edge 834 of the document 830 will be visible through the overlying transparent portions of the enclosure 814 and the supported resilient strip 820.

The supported document 830 can be removed by manually withdrawing the document 830 downwardly from the accessory 800, and from beneath the rolled resilient strip 820. Any suitable number of documents can be added to and removed from the accessory 800 without having to first remove the accessory from the display board. Additionally, the accessory 800 can be removed from or moved anywhere along the dry-erase writing surface as needed.

### PARTS LIST FOR FIGS. 1-8(c)

10 display board (display panel)
16 front surface or side
20 intermediate core layer
24 rear backing layer
28 bent shape, panel
100 display board (display panel)
130 corner pieces
140 cleat
144 longitudinal supporting slot
150 frame
160 side trim
164 edge trim section
230 display board
231 glass sheet
232 tray
234 lowermost or bottom edge
238 arm
240 back side, display board
242 arm
246 tray section
250 display board
254 steel backing sheet
258 extrusion
262 extrusion
264 fasteners
266 tempered glass sheet
280 hidden pen/eraser holder
284 eraser pens
288 eraser
300 display board accessory
304 top panel member
306 bottom panel member
308 lower edge, top panel member
310 lower edge, bottom panel member
312 left side edge, top panel member
313 left side edge, bottom panel member
314 upper edge, top panel member
315 upper edge, bottom panel member
319 upper tab portion, bottom panel member
321 marginal portion, right side edge, top panel member
322 marginal portion, right side edge, bottom panel member
332 triangular shaped portion, top panel member
340 rear facing surface, bottom panel member
344 elongate sections, micro or nano-suction material
350 elongate section, micro or nano-suction material
354 document
360 mounting holes
400 display board accessory
404 letters/numbers
408 shapes
418 micro or nano-suction material
420 rear facing side or surface
424 plastic sheet
428 plastic sheet
500 display board accessory
504 support member
508 front facing side, support member
512 mounting rails
516 rear facing side, support member
520 card
522 C-channels
524 micro or nano-suction material
530 display board
600 display board accessory
604 U-shaped strip member
608 face, strip member
612 magnetic strips
616 leg section
618 leg section
620 section of micro or nano-suction material
624 display board
626 arrow
700 display board accessory
704 color block
706 front surface
708 back surface
716 clear plastic sheet
720 micro or nano-suction material
800 display board accessory
804 panel, rigid
808 rear or bottom facing surface, panel
812 front or top facing surface, panel
814 transparent enclosure
820 resilient transparent strip
824 section, micro or nano-suction material
830 document
834 upper edge, document

It will be noted that the foregoing description is directed to a number of specific examples. It should also be understood that literally any display board accessory can be configured with retention features in accordance with the present invention. For example, eraser trays that are typically integral to a display board system can also include microsuction material in order to permit releasable attachment. In addition, it should be noted that other non-magnetic or non-adhesive means of retention can be used in lieu of micro-or nano-suction material. For example, the rear facing surface of a display board accessory can alternatively include other dry adhesives such as “sticky pads” or “gecko tape” to create retention. A “sticky pad” is a friction device made from a soft rubber material that is used to prevent objects from sliding on a surface by effectively increasing the friction between the object and the surface of the device. The “pad” has large friction coefficients to prevent slippage. The adhesion of a “gecko tape” is based upon vanDer Waals forces for purposes of adhering the tape to an object of interest and is modeled from geckos and similar animals. In each case, the sticky pad or gecko tape can be adhesively applied as a material similar to the flexible micro or nano-suction material with the retention feature(s) being provided on a outwardly directed surface. It will be readily apparent to a person of sufficient skill that other suitable modifications can be made to any or all the embodiments herein described and as covered by the following claims.

We claim:

1. An accessory for use with a display board having a dry-erasable writing surface, the accessory comprising:
a support member having a first surface and an opposing second surface; and
at least one section of micro or nano-suction material disposed on the first surface that is configured for releasable attachment to the dry-erase writing surface of the display board, the at least one section of micro or nano-suction material having a plurality of tightly spaced cavities or bubbles retaining air projecting from the first surface.

2. The display board accessory as recited in claim 1, in which the dry-erasable writing surface of the display board is made from a transparent or optically clear material.

3. The display board accessory as recited in claim 2, in which the transparent or optically clear material is glass or an acrylic.

4. The display board accessory as recited in claim 1, in which the second surface of the support member retains at least one label that may include a wipeable erasable surface.

5. The display board accessory as recited in claim 1, in which the support member comprises at least one feature configured to retain a card in relation to the second surface.

6. The display board accessory as recited in claim 5, in which the at least one feature comprises a pair of spaced rails at upper and lower edges of the support member, each of the rails defining channels shaped for supporting the edges of a card.

7. The display board accessory as recited in claim 1, in which the micro or nano-suction material includes an adhesive layer that is attached to the first surface of the support member.

8. The display board accessory as recited in claim 1, in which the micro or nano-suction material comprises a flexible support having a facing side and an opposite side, each side having a plurality of said tightly spaced air filled bubbles or cavities.

9. The display board accessory as recited in claim 1, comprising at least one feature that is configured to support at least one document.

10. The display board accessory as recited in claim 9, in which the accessory includes a transparent panel secured to the support member along a bottom edge and one side edge in which at least one document can be retained between the support member and the transparent panel which may include an elongate strip of microsuction material to maintain the transparent panel in a closed position.

11. A dry-erase display board system, said system comprising:
a display board having a clear or transparent dry-erasable writing surface;
at least one accessory comprising a support member having a first surface and a second surface, the first surface having a section of micro or nano-suction material disposed thereon that is configured to releasably adhere to the dry-erasable writing surface of the display board.

12. The display board system as recited in claim 11, in which the clear or optically transparent dry-erasable writing surface of the display board is made from one of tempered glass or acrylic.

13. The display board system as recited in claim 11, wherein the micro or nano-suction material includes an adhesive layer that is attached to the first surface of the support member.

14. The display board system as recited in claim 11, wherein the micro or nano-suction material is arranged on a flexible substrate having opposing sides and in which each side includes the plurality of tightly spaced cavities or bubbles, enabling attachment to an accessory and a display board.

15. The display board system as recited in claim 11, in which the second surface of the support member retains at least one label that may include a wipeable erasable surface.

16. The display board system as recited in claim 11, in which the support member includes at least one feature that permits the retention of a card relative to the second surface.

17. The display board system as recited in claim 16, in which the support member includes a pair of spaced rails at upper and lower edges, each of the spaced rails having channels configured and shaped for supporting edges of a card.

18. The display board system as recited in claim 11, in which the at least one accessory includes at least one feature configured to support at least one document.

19. The display board system as recited in claim 11, in which the at least one accessory comprises die cut letters, numbers and/or symbols.

20. A method for producing accessories for use with a display board having a dry-erasable writing surface, the method comprising:
providing an accessory comprising a support member having a first surface and an opposing second surface; and
attaching at least one section of micro or nano-suction material to the second surface of the support member in which the micro or nano-suction material is configured to releasably adhere to a dry-erasable writing surface of the display board.
